(19) United States
(12) Patent Application Publication
(10) Pub. No.: US 2024/0387874 A1
(43) Pub. Date: Nov. 21, 2024

(54) ELECTROLYTES FOR LITHIUM ION AND LITHIUM METAL BATTERIES

(71) Applicant: Battelle Memorial Institute, Richland, WA (US)

(72) Inventors: Wu Xu, Richland, WA (US); Hao Jia, Richland, WA (US)

(73) Assignee: Battelle Memorial Institute, Richland, WA (US)

(21) Appl. No.: 18/696,275

(22) PCT Filed: Sep. 27, 2022
(86) PCT No.: PCT/US2022/044888

§ 371 Date: Mar. 27, 2024

Related U.S. Application Data
(60) Provisional application No. 63/251,244, filed on Oct. 1, 2021.

(51) Int. Cl. H01M 10/0569; H01M 10/052; H01M 10/0525; H01M 10/0567; H01M 10/0568; H01M 10/42

(52) U.S. Cl. CPC H01M 10/0569; H01M 10/052; H01M 10/0525; H01M 10/0567; H01M 10/0568; H01M 10/4235; H01M 2300/0028

(57) ABSTRACT

Electrolytes for lithium ion and lithium metal batteries include (i) a lithium salt, (ii) a nonaqueous solvent comprising a flame retardant, wherein the lithium salt is soluble in the solvent, and (iii) a diluent having a flash point greater than 90° C., wherein the lithium salt has a solubility in the diluent at least 10 times less than a solubility of the lithium salt in the nonaqueous solvent. The electrolyte may further include an additive having a different composition than the lithium salt, a different composition than the nonaqueous solvent, and a different composition than the diluent.

### CROSS-REFERENCE TO RELATED APPLICATION

This application claims the benefit of the earlier filing date of U.S. Provisional Patent Application No. 63/251,244, filed Oct. 2, 2021, which is incorporated by reference in its entirety herein.

### ACKNOWLEDGMENT OF GOVERNMENT SUPPORT

This invention was made with Government support under Contract No. DE-AC05-76RL01830,awarded by the U.S. Department of Energy. The Government has certain rights in the invention.

### FIELD

This disclosure is directed to electrolytes for stable cycling of lithium metal and lithium ion batteries.

### BACKGROUND

The high flammability of state-of-the-art liquid electrolytes is a major hazard for the safe operation of lithium (Li) ion batteries (LIBs) and Li metal batteries (LMBs). The flammability of the state-of-the-art liquid electrolytes originates from the use of flammable organic carbonate solvents. A need exists for safer electrolytes that also provide cycling stability and long cycle life.

### SUMMARY

Embodiments of electrolytes for lithium ion batteries (LIBs) and lithium metal batteries (LMBs) are disclosed. Batteries including the electrolytes also are disclosed.

In some embodiments, the electrolyte comprises (i) a lithium salt, (ii) a nonaqueous solvent comprising a flame retardant, wherein the lithium salt is soluble in the solvent, and (iii) a diluent having a flash point greater than 90° C., wherein the lithium salt has a solubility in the diluent at least 10 times less than a solubility of the lithium salt in the nonaqueous solvent. The nonaqueous solvent may have a flash point greater than 60° C. In some implementations, the electrolyte, as a whole, has a flash point greater than 75° C., greater than 100° C., greater than 125° C., greater than 150° C., or even greater than 160° C.

In any or all of the foregoing or following embodiments, the flame retardant may comprise an organic phosphate, an organic phosphonate, an organic phosphazene, an organic phosphoramide, or any combination thereof. Exemplary flame retardants include trimethyl phosphate (TMPa), triethyl phosphate (TEPa), triphenyl phosphate (TPPa), tributyl phosphate, tris(2,2,2-trifluoroethyl) phosphate, bis(2,2,2-trifluoroethyl) methyl phosphate, dimethyl methylphosphonate (DMMP), diethyl ethylphosphonate, diethyl phenylphosphonate, bis(2,2,2-trifluoroethyl) methylphosphonate, hexamethylphosphazene, hexamethylphosphoramide, and combinations thereof.

In any or all of the foregoing or following embodiments, the diluent may comprise an organic phosphate, an organic phosphite, or a combination thereof. Exemplary diluents include tris(2,2,2-trifluoroethyl) phosphite (TTFEPi), triphenyl phosphite (TPPi), tris(2,2,3,3,3-pentafluoropropyl) phosphate (5F-TPrP), tris(1,1,1,3,3,3-hexafluoropropan-2-yl) phosphate (HFiP), tris(1,1,1,3,3,3-hexafluoropropan-2-yl) phosphite (THFPP), dibutyl phosphite, di-tert-butyl phosphite, and combinations thereof.

In any or all of the foregoing or following embodiments, the electrolyte may further comprise an additive having a different composition than the lithium salt, a different composition than the nonaqueous solvent, and a different composition than the diluent. Exemplary additives include ethylene carbonate (EC), fluoroethylene carbonate (FEC), vinylene carbonate (VC), 4-vinyl-1,3-dioxolan-2-one (vinyl ethylene carbonate, VEC), 4-methylene-1,3-dioxolan-2-one (4-methylene ethylene carbonate, MEC), 4,5-dimethylene-1,3-dioxolan-2-one, allyl acetate, prop-1-ene-1,3-sultone (PES), 1,3,2-dioxathiolane-2-oxide (i.e. ethylene sulfite, ES), 1,3,2-dioxathiolane-2,2-dioxide (i.e. ethylene sulfate, DTD), 1,3,2-dioxathiane-2,2-dioxide (i.e. 1,3-dipropylene sulfate), lithium 2-trifluoromethyl-4,5-dicyanoimidazole (LiTDI), lithium bis(oxalato)borate (LiBOB), lithium difluoro(oxalato)boate (LiDFOB), lithium hexafluorophosphate (LiPF₆), lithium difluorophosphate (LiPO₂F₂), lithium hexafluoroarsenate (LiAsF₆), 3-methyl-1,4,2-dixoazol-5-one (MDO), 2-oxo-1,3,2-dioxathiane, butanedinitrile, pentanedinitrile, hexanedinitrile, tris(pentafluorophenyl) phosphine, 1-methylsulfonylethene, 1-ethenylsulfonylethane, and combinations thereof.

In any or all of the foregoing or following embodiments, the electrolyte may have a lithium salt-nonaqueous solvent-diluent molar ratio of 1:x:y where x=0.1-5.0 and y=0.1-8.0. In some embodiments, the electrolyte has a lithium salt-nonaqueous solvent-diluent-additive molar ratio of 1:x:y:z where x=0.1-5.0.y=0.1-8.0, and z=0-1.0.

A battery includes an electrolyte as disclosed herein, an anode, and a cathode. In some embodiments, the anode is lithium metal, a carbon-based anode, a silicon-based anode, or a silicon- and carbon-based anode.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic illustration of a conventional high concentration electrolyte (HCE) comprising a lithium salt and a solvent.

FIG. 2 is a schematic illustration of an exemplary localized high concentration electrolyte (LHCE) comprising a lithium salt, a solvent in which the lithium salt is soluble, and a diluent, i.e., a component in which the lithium salt is insoluble or poorly soluble compared to the solvent.

FIG. 3 is a schematic diagram of an exemplary rechargeable battery.

FIG. 4 is a schematic diagram of a side elevation view of a simplified exemplary pouch cell.

FIG. 5 is a series of photographs illustrating relative flammability of a conventional electrolyte (E-baseline) and three LHCEs—LiFSI-TMPa-TTFEPi (SE-NA), LiFSI-TMPa-TTFEPi-EC (SE-E), and LiFSI-TMPa-TTFEPi-FEC (SE-F)

FIG. 6 is a bar graph showing the flash points of E-baseline, SE-NA, SE-E, and SE-F.

FIG. 7 is a graph of ionic conductivity versus temperature for E-baseline, SE-NA, SE-E, and SE-F.

FIGS. 8A and 8B show the average Li Coulombic efficiencies (CEs) of E-baseline, SE-NA, SE-E, and SE-F in Li∥Cu cells (8A) and voltage profiles of Li∥Li cells with the electrolytes upon repeated Li deposition stripping (8B; current density—1 mA cm⁻², temperature—25° C., areal capacity per step—1 mAh cm⁻², electrolyte content 75 μL).

FIG. 9 is a graph showing the average specific discharge capacity as a function of cycle number for Li∥LiFePO₄ cells including the E-baseline and SE-NA electrolytes.

FIG. 10 is a graph showing long-term cycling performance of graphite∥LiFePO₄ cells including E-baseline, SE-NA, SE-E, and SE-F.

### DETAILED DESCRIPTION

Nonflammable electrolytes for use in lithium (Li) metal batteries (LMBs) and Li ion batteries (LIBs) are disclosed. Previous approaches to suppress electrolyte flammability can be divided into three major approaches: (1) addition of flame retardants (FRs), (2) use of non-flammable solvents, and (3) employing flame retardants as solvating solvents in localized high concentration electrolytes (LHCEs), also referred to as localized superconcentrated electrolytes (LSEs). The most common approach to suppress the flammability of the electrolyte has been to introduce a miscible FR into the electrolyte. However, the introduced FR often interferes with the formation of an effective solid electrolyte interphase (SEI) on the anodes of LIBs (e.g., carbon- and/or silicon-based anodes), leading to deteriorated electrochemical performance. For this reason, the FR content is usually limited, and often, the flammability of the electrolyte cannot be fully suppressed due to such limitation.

Another approach is to use a nonflammable solvent in place of the usual flammable organocarbonate solvent. The most common nonflammable solvents are room temperature ionic liquids (RTILs). However, RTILs usually have relatively poor compatibility with carbon- and/or silicon-based anodes. Although compatibility may be improved with addition of an SEI-forming additive and/or modification of the RTIL molecular structure, LIBs using RTILs generally exhibit inferior cycle life compared to cells using conventional electrolytes. In addition, the low Li salt solubility in RTILs, the high viscosity of RTILs, and the high price of RTILs also impede their applications in commercial LIBs.

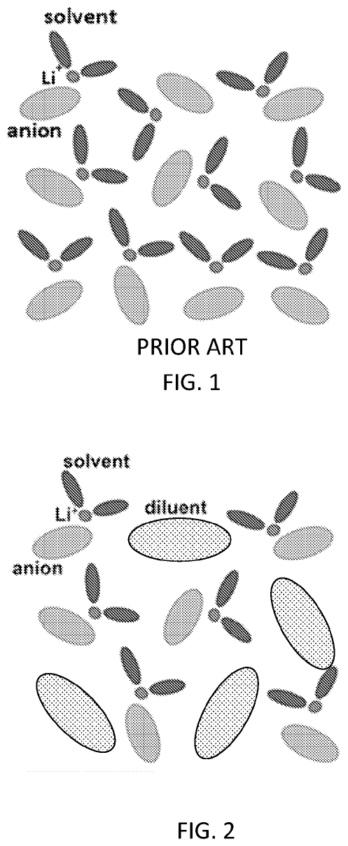

Previously, the incompatibility issue between the anode and FR has been addressed by use of LHCEs. LHCEs are prepared by introducing a non-solvating diluent into a high concentration electrolyte (HCE). An HCE comprises a solvent and a salt with a salt concentration of at least 3 M. Some HCEs have a salt concentration of at least 4 M or at least 5 M. In certain instances, the salt molarity may be up to 20 M or more, e.g., aqueous LiTFSI. FIG. 1 is a schematic illustration of a conventional HCE comprising a solvent and a lithium salt. Desirably, all or a large majority of the solvent molecules are coordinated with a lithium cation in the HCE. The reduced presence of free, uncoordinated solvent molecules may facilitate formation of a stabilized SEI layer, increase Coulombic efficiency (CE) of a lithium metal anode and/or reversible insertion of Li-ions into a carbon- (e.g., graphite and/or hard carbon) and/or silicon-based anode, and/or increase cycling stability of a battery including the electrolyte. FIG. 2 is a schematic illustration of an exemplary LHCE including a lithium salt, a solvent in which the lithium salt is soluble, and a diluent in which the lithium salt is insoluble or poorly soluble. As shown in FIG. 2, the lithium ions remain coordinated with solvent molecules after addition of the diluent. The anions are also in proximity to, or coordinated with, the lithium ions. Thus, localized regions of solvent-cation-anion aggregates are formed. In contrast, the lithium ions and anions are not associated with the diluent molecules, which remain free in the solution. Evidence of this electrolyte structure with regions of locally concentrated salt/solvent and free diluent molecules is seen by Raman spectroscopy (e.g., as shown in US 2018/0251681 A1, which is incorporated by reference herein), NMR characterization, and molecular dynamics (MD) simulations. Thus, although the solution as a whole is less concentrated than the solution of FIG. 1, there are localized regions of high concentration where the lithium cations are associated with the solvent molecules. There are few to no free solvent molecules in the diluted electrolyte, thereby providing the benefits of an HCE without the associated disadvantages. Since effective SEIs can be formed by the synergetic decomposition of anions and FRs, these LHCEs can achieve good cycling performance in both LIBs and LMBs.

However, to achieve the unique solvation structure of LHCEs, the diluents have to meet the rigorous criteria of miscibility with the solvating solvents, negligible solvation of Li salts, low viscosity, and compatibility with electrodes. Because of these rigorous criteria, the state-of-the-art diluents for fabricating LHCEs have been predominantly hydrofluoroethers (HFEs) like 1,1,2,2-tetrafluoroethyl-2,2,3,3-tetrafluoropropyl ether (TTE) and partially fluorinated orthoformates. However, these HFEs generally exhibit high volatility and low flash points, which can be hazardous for LIBs and LMBs. Using FRs, such as trimethyl phosphate (TMPa) and triethyl phosphate (TEPa), as the solvents for LHCEs significantly reduces the flammability of the LHCEs. However, while these LHCEs are difficult to ignite by an external flame, they nonetheless exhibit very low flash points. For example, in the case of lithium bis(fluorosulfonyl)imide (LiFSI)-TMPa-TTE electrolytes, the flash point of the electrolytes is merely ˜31° C., which is only 2° C. higher than the pure TTE and only marginally higher than a conventional LiPF₆-organocarbonate electrolyte (1.0 M LiPF₆EC-EMC (3:7 wt)+2 wt % VC). According to the Flammable and Combustible Liquids Code released by the National Fire Protection Association of the United States, these LHCEs are categorized as flammable liquids since their flash points are lower than the threshold value of 37.8° C.

Thus, a need remains for safer LHCEs. This problem is solved by incorporating a nonflammable diluent into the LHCE. Embodiments of the disclosed electrolytes comprise an active lithium salt, a nonaqueous solvent comprising a flame retardant and a diluent having a flash point greater than 90° C., wherein the lithium salt has a solubility in the diluent at least 10 times less than a solubility of the lithium salt in the nonaqueous solvent. The electrolyte may further include an additive. In some embodiments, the electrolyte, as a whole, has a flash point greater than 75° C., greater than 100° C., greater than 125° C., greater than 150° C., or even greater than 160° C.

### I. Definitions and Abbreviations

The following explanations of terms and abbreviations are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the following detailed description and the claims.

Unless otherwise indicated, all numbers expressing quantities of components, molecular weights, molarities, voltages, capacities, and so forth, as used in the specification or claims are to be understood as being modified by the term “about.” Accordingly, unless otherwise implicitly or explicitly indicated, or unless the context is properly understood by a person of ordinary skill in the art to have a more definitive construction, the numerical parameters set forth are approximations that may depend on the desired properties sought and/or limits of detection under standard test conditions/methods as known to those of ordinary skill in the art. When directly and explicitly distinguishing embodiments from discussed prior art, the embodiment numbers are not approximates unless the word “about” is recited.

Although there are alternatives for various components, parameters, operating conditions, etc. set forth herein, that does not mean that those alternatives are necessarily equivalent and/or perform equally well. Nor does it mean that the alternatives are listed in a preferred order unless stated otherwise.

Definitions of common terms in chemistry may be found in Richard J. Lewis, Sr. (ed.), Hawley's Condensed Chemical Dictionary, published by John Wiley & Sons, Inc., 2016 (ISBN 978-1-118-13515-0).

In order to facilitate review of the various embodiments of the disclosure, the following explanations of specific terms are provided:

Additive: As used herein, the term “additive” refers to a component of an electrolyte that is present in an amount of greater than zero and less than or equal to 10 wt % or less than or equal to 10 mol % of the electrolyte components.

Anode: An electrode through which electric charge flows into a polarized electrical device. From an electrochemical point of view, negatively-charged anions move toward the anode and/or positively-charged cations move away from it to balance the electrons leaving via external circuitry. In a discharging battery or galvanic cell, the anode is the negative terminal where electrons flow out. If the anode is composed of a metal, electrons that it gives up to the external circuit are accompanied by metal cations moving away from the electrode and into the electrolyte. When the battery is recharged, the anode becomes the positive terminal where electrons flow in and metal cations are reduced. Unless otherwise specified, the term “anode” as used herein, refers to the negative electrode or terminal where electrons flow out during discharge.

Capacity: The capacity of a battery is the amount of electrical charge a battery can deliver. The capacity is typically expressed in units of mAh, or Ah, and indicates the maximum constant current a battery can produce over a period of one hour. For example, a battery with a capacity of 100 mAh can deliver a current of 100 mA for one hour or a current of 5 mA for 20 hours. The term specific capacity refers to capacity per unit of mass. In this application, the mass specifically refers to the mass of the active material in the electrodes. Specific capacity may be expressed in units of mAh/g. The term specific areal capacity refers to capacity per unit of area of the electrode or active material. Specific areal capacity may be expressed in units of mAh/cm².

Carbon-based anode/negative electrode: A majority of the total anode mass is carbon (e.g., graphite, hard carbon, soft carbon), such as at least 70 wt %, at least 80 wt %, or at least 90 wt % carbon.

Carbon- and silicon-based anode/negative electrode: A majority of the total anode mass is carbon (e.g., hard carbon, soft carbon, graphite) and silicon or silicon monoxide, such as at least 70 wt %, at least 80 wt %, or at least 90 wt % carbon and silicon.

Carbon/silicon composite: As used herein, the term carbon/silicon composite refers to a material including both carbon (such as graphite, soft carbon, and/or hard carbon) and silicon. A composite material is made from two or more constituent materials that, when combined, produce a material with characteristics different than those of the individual components. Carbon/silicon composites may be prepared, for example, by pyrolysis of pitch embedded with graphite and silicon powders (see, e.g., Wen et al., Electrochem Comm 2003, 5(2):165-168).

Cathode: An electrode through which electric charge flows out of a polarized electrical device. From an electrochemical point of view, positively charged cations invariably move toward the cathode and/or negatively charged anions move away from it to balance the electrons arriving from external circuitry. In a discharging battery or galvanic cell, the cathode is the positive terminal, toward the direction of conventional current. This outward charge is carried internally by positive ions moving from the electrolyte to the positive cathode, where they may be reduced. When the battery is recharged, the cathode becomes the negative terminal where electrons flow out and metal atoms (or cations) are oxidized. Unless otherwise specified, the term “cathode” as used herein, refers to the positive electrode during discharge.

Cell: As used herein, a cell refers to an electrochemical device used for generating a voltage or current from a chemical reaction, or the reverse in which a chemical reaction is induced by a current. A battery includes one or more cells. The terms “cell” and “battery” are used interchangeably when referring to a battery containing only one cell.

Consists essentially of: By “consists essentially of” is meant that the electrolyte does not include other components that materially affect the properties of the electrolyte alone or in a system including the electrolyte. Electrolyte properties include, but are not limited to, Coulombic efficiency, cycling stability, electrochemical stability window, conductivity, viscosity, volatility, and flammability. For example, the electrolyte does not include any electrochemically active component (i.e., a component (an element, an ion, or a compound) that is capable of forming redox pairs having different oxidation and reduction states, e.g., ionic species with differing oxidation states or a metal cation and its corresponding neutral metal atom) other than the lithium salt in an amount sufficient to affect performance of the electrolyte, and does not include additional solvents, diluents, or additives, besides those listed, in a significant amount (e.g., >1 wt %). When referring to a single component of the electrolyte, by “consists essentially of” is meant that the component does not include other constituents that materially affect the properties of the electrolyte alone or in a system including the electrolyte.

Coulombic efficiency (CE): The efficiency with which charges are transferred in a system facilitating an electrochemical reaction. CE may be defined as the amount of charge exiting the battery during the discharge cycle divided by the amount of charge entering the battery during the charging cycle. For example, CE of Li∥Cu cells may be defined as the amount of charge flowing out of the battery during stripping process divided by the amount of charge entering the battery during plating process.

DMMP: Dimethyl methylphosphonate

EC: Ethylene carbonate

Electrolyte: A substance containing free ions that behaves as an ionically conductive medium. Electrolytes generally comprise ions in a solution, but molten electrolytes and solid electrolytes also are known.

5F-TPrP: Tris(2,2,3,3,3-pentafluoropropyl) phosphate

FEC: Fluoroethylene carbonate

Flame retardant (FR): As used herein, the term “flame retardant” refers to an agent that, when incorporated into an electrolyte in a sufficient amount, renders the electrolyte nonflammable or flame retarded as defined herein.

Flammable: The term “flammable” refers to a material that will ignite easily and burn rapidly. As used herein, the term “nonflammable” means that an electrolyte, or component of the electrolyte, will not ignite or burn during operation of an electrochemical device including the electrolyte. The terms “flame retarded” and “low flammability” are interchangeable and mean that a portion of the electrolyte may ignite under some conditions, but that any resulting ignition will not propagate throughout the electrolyte. Flammability can be measured by determining the self-extinguishing time (SET) of the electrolyte or a component of the electrolyte. The SET is determined by a modified Underwriters Laboratories test standard 94 HB. An electrolyte is immobilized on an inert ball wick cut from glass fibers, such as a ball wick having a diameter of ˜0.3-0.5 cm, which is capable of absorbing 0.05-1 g electrolyte. The wick is then ignited, and the time for the flame to extinguish is recorded. The time is normalized against the sample weight. If the electrolyte does not catch flame, the SET is zero and the electrolyte is nonflammable. Electrolytes having an SET of <6 s/g are also considered nonflammable. If the SET is >20 s/g, the electrolyte is considered to be flammable. When the SET is between 6-20 s/g, the electrolyte is considered to be flame retarded or have low flammability.

Flash point: The lowest temperature at which an organic compound vaporizes sufficiently to ignite when exposed to an ignition source. Flashpoint can be determined according to the following testing standards ASTM D 3278, ASTM D 3828, ASTM D 4206, ISO 3679, and/or ISO 3680 using a Rapid Tester® RT-00001 (ERDCO Engineering Corporation, Evanston, IL).

Graphite-based anode/negative electrode: A majority of the total anode mass is graphite, such as at least 70 wt %, at least 80 wt %, or at least 90 wt % graphite.

Graphite-and silicon-based anode/negative electrode: A majority of the total anode mass is graphite and silicon, such as at least 70 wt %, at least 80 wt %, or at least 90 wt % graphite and silicon.

HFIP: Tris(1,1,1,3,3,3-hexafluoropropan-2-yl) phosphate

LiAsF₆: Lithium hexafluoroarsenate

LiBETI: Lithium bis(pentafluoroethylsulfonyl)imide

LiBOB: Lithium bis(oxalato)borate

LiDFOB: Lithium difluoro(oxalato)borate

LiFSI: Lithium bis(fluorosulfonyl)imide

LiFTFSI: Lithium (fluorosulfonyl)(trifluoromethylsulfonyl)imide

LiPF₆: Lithium hexafluorophosphate

LiTDI: Lithium 2-trifluoromethyl-4,5-dicyanoimidazole

LiTf: Lithium trifluoromethanesulfonate

LiTFSI: Lithium bis(trifluoromethylsulfonyl)imide

Localized superconcentrated electrolyte (LSE) or localized high-concentration electrolyte (LHCE): As used herein, the terms LSE and LHCE may be used interchangeably and refer to an electrolyte including a lithium salt, a solvent in which the lithium salt is soluble, and a diluent in which the lithium salt is insoluble or poorly soluble. The lithium ions remain coordinated with solvent molecules after addition of the diluent. The anions are also in proximity to, or associated with, the lithium ions. Thus, localized regions of solvent-cation-anion aggregates are formed. In contrast, the lithium ions and anions are not associated with the diluent molecules, which remain free in the solution. There are few to no free solvent molecules (i.e., most or all solvent molecules are coordinated by lithium ions) in the diluted electrolyte, thereby providing the benefits of a conventional high-concentration electrolyte (e.g., an electrolyte with a salt concentration of at least 3 mol/L or M, molarity) without the associated disadvantages.

Negative electrode: An electrode having a negative potential during charge and discharge of a battery or electrolytic cell.

Positive electrode: An electrode having a positive potential during charge and discharge of a battery or electrolytic cell.

Silicon-based anode/negative electrode: A majority of the total anode mass is silicon, such as at least 70 wt %, at least 80 wt %, or at least 90 wt % silicon.

Solid electrolyte interphase (SEI) layer: A passivation layer comprising electrolyte decomposition products formed on the anode of lithium-ion batteries during the first few cycles.

Soluble: Capable of becoming molecularly or ionically dispersed in a solvent to form a homogeneous solution.

TEPa: Triethyl phosphate

THFPP: Tris(1, 1, 1,3,3,3-hexafluoropropan-2-yl) phosphite

TMPa: Trimethyl phosphate

TPPa: Triphenyl phosphate

TPPi: Triphenyl phosphite

TTFEPi: Tris(2,2,2-trifluoroethyl) phosphite

### II. Localized High Concentration Electrolytes

Embodiments of the disclosed localized high concentration electrolytes (LHCEs) comprise (i) a lithium salt, (ii) a nonaqueous solvent comprising a flame retardant, wherein the lithium salt is soluble in the solvent, and (iii) a diluent having a flash point greater than 90° C., wherein the lithium salt has a solubility in the diluent at least 10 times less than a solubility of the lithium salt in the nonaqueous solvent. In some embodiments, the LHCE further comprises an additive having a different composition than the lithium salt, a different composition than the nonaqueous solvent, and a different composition than the diluent. In some implementations, the LHCE consists essentially of, or consists of, the lithium salt, the nonaqueous solvent, the diluent, and, optionally, the additive.

The solubility of the lithium salt in the nonaqueous solvent (in the absence of diluent) may be greater than 3 M, such as at least 4 M or at least 5 M. In some embodiments, the solubility and/or concentration of the lithium salt in the nonaqueous solvent is from 3 M to 10 M, such as from 3 M to 8 M, from 4 M to 8 M, or from 5 M to 8 M. In certain embodiments, the concentration may be expressed in terms of molality and the concentration of the lithium salt in the nonaqueous solvent in the absence of diluent) may be from 3 m to 25 m, such as from 5 m to 21 m, or 10 m to 21 m. In contrast, the molar or molal concentration of the lithium salt in the electrolyte as a whole (salt, nonaqueous solvent, diluent, and additive) may be at least 20% less than the molar or molal concentration of the lithium salt in the nonaqueous solvent, such as at least 30% less, at least 40% less, at least 50% less, at least 60% less, or even at least 70% less than the molar or molal concentration of the lithium salt in the nonaqueous solvent. For example, the molar or molal concentration of the lithium salt in the electrolyte may be 20-80% less, 20-70% less, 30-70% less, or 30-50% less than the molar or molal concentration of the lithium salt in the nonaqueous solvent. In some embodiments, the molar concentration of the lithium salt in the electrolyte is within a range of 0.5 M to 6 M, 0.5 M to 3 M, 0.5 M to 2 M, 0.75 M to 2 M, or 0.75 M to 1.5 M.

The lithium salt, or combination of lithium salts, participates in the charge and discharge processes of a cell including the electrolyte. Exemplary lithium salts include, but are not limited to, comprises lithium bis(fluorosulfonyl)imide (LiFSI), lithium bis(trifluoromethanesulfonyl)imide (LiTFSI), lithium (fluorosulfonyl)(trifluoromethylsulfonyl)imide (LiFTFSI), lithium bis(pentafluoroethanesulfonyl)imide (LiBETI), lithium trifluoromethanesulfonate (LiTf, LiCF₃SO₃), LiPF₆, LiAsF₆, LiBF₄, LiCIO₄, lithium bis(oxalato)borate (LiBOB), lithium difluoro(oxalato)borate (LiDFOB), LiI, LiBr, LiCl, LiSCN, LiNO₃, LiNO₂, Li₂SO₄, and combinations thereof. In some embodiments, the salt is LiFSI, LiTFSI, LiBETI, LiTFTSI, LiTf, or a combination thereof. In certain examples, the salt is LiFSI.

The nonaqueous solvent comprises, consists essentially of, or consists of a flame retardant, wherein the lithium salt is soluble in the nonaqueous solvent. By “nonaqueous” is meant that the solvent does not include any added water and comprises from 0-0.1 wt % water found as an impurity in the solvent. By “consists essentially of” is meant that the nonaqueous solvent does not comprise additional solvents, besides the flame retardant, in a significant amount (e.g., >1 wt % or >1 mol % of the solvent). For example, a nonaqueous solvent consisting essentially of a flame retardant does not further comprise a flammable component, such as a flammable ester or ether. The term “nonaqueous solvent” is also understood to exclude the additives disclosed below, including any additives in which the lithium salt may be soluble. In some embodiments, the flame retardant is a liquid at ambient temperature (e.g., 20-30° C.). In any of the foregoing or following embodiments, the solvent may be nonflammable.

In any or all of the foregoing or following embodiments, the nonaqueous solvent may have a flash point greater than 60° C. In some embodiments, the nonaqueous solvent has a flash point greater than 75° C., or greater than 100° C.

Suitable flame retardants include, but are not limited to, phosphorus containing compounds. In some embodiments, the flame retardant comprises an organic phosphate, an organic phosphonate, an organic phosphazene, an organic phosphoramide, or any combination thereof. Exemplary flame retardants are shown in Table 1 and include, but are not limited to, trimethyl phosphate (TMPa), triethyl phosphate (TEPa), triphenyl phosphate (TPPa), tributyl phosphate, tris(2,2,2-trifluoroethyl) phosphate, bis(2,2,2-trifluoroethyl) methyl phosphate, dimethyl methylphosphonate (DMMP), diethyl ethylphosphonate, diethyl phenylphosphonate, bis(2,2,2-trifluoroethyl) methylphosphonate, hexamethylphosphazene, hexamethylphosphoramide, and combinations thereof. In any or all of the foregoing or following embodiments, the flame retardant may comprise TMPa, TEPa, TTPa, DMMP, or any combination thereof. In certain implementations, the flame retardant comprises TMPa. In some embodiments, the nonaqueous solvent consists essentially of or consists of TMPa, TEPa, TTPa, DMMP, or any combination thereof. In certain embodiments, the nonaqueous solvent consists essentially of or consists of TMPa.

TABLE 1
Exemplary Solvents

| Flame | | Flash |
|---|---|---|
| retardant solvent | Chemical structure | Point/° C. |
| Trimethyl phosphate (TMPa) | 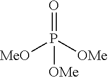 | 107 |
| Triethyl phosphate (TEPa) | 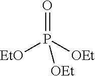 [SMILES: CCOP(=O)(OCC)OCC] | 107 |
| Triphenyl phosphate (TTPa) | 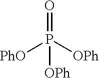 [SMILES: O=P(Oc1ccccc1)(Oc1ccccc1)Oc1ccccc1] | 224 |
| Dimethyl methylphosphonate (DMMP) | 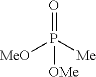 | 69 |
| Tributyl phosphate | 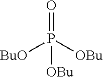 | 146 |
| Tris(2,2,2-trifluoroethyl) phosphate | 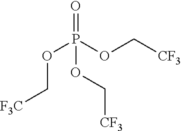 [SMILES: O=P(OCC(F)(F)F)(OCC(F)(F)F)OCC(F)(F)F] | None |
| Bis(2,2,2-trifluoroethyl) methyl phosphate | 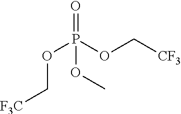 [SMILES: COP(=O)(OCC(F)(F)F)OCC(F)(F)F] | — |
| Diethyl ethylphosphonate | 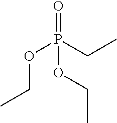 | 104.4 |
| Diethyl phenylphosphonate | 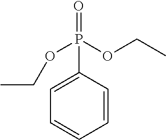 | 267 |
| Bis(2,2,2-trifluoroethyl) methylphosphonate | 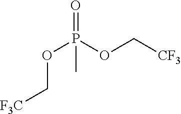 | 80 |
| Hexamethyl- phosphoramide | 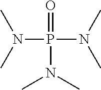 | 104-105 |
| Hexamethyl- phosphazene | 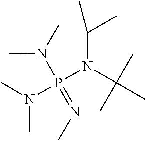 [SMILES: CN=P(N(C)C)(N(C)C)N(C(C)C)C(C)(C)C] | — |

The LHCE includes a diluent having a flash point greater than 90° C. The lithium salt has a solubility in the diluent at least 10 times less than a solubility of the lithium salt in the nonaqueous solvent. For instance, if the salt has a solubility of 5 M in the nonaqueous solvent, the diluent is selected such that the salt has a solubility of less than 0.5 M in the diluent. In some embodiments, the lithium salt has a solubility in the nonaqueous solvent that is at least 10 times, at least 15 times, at least 20 times, at least 25 times, at least 30 times, at least 40 times, or at least 50 times greater than the salt's solubility in the diluent. The diluent is selected to be stable with the anode, cathode, and current collectors at low lithium salt concentrations (e.g., ≤3 M) or even without the lithium salt. Advantageously, the diluent preserves the unique solvation structure of solvent-cation-anion aggregates while simultaneously increasing the flash point of the LHCE. The diluent is considered inert because it is not interacting with the lithium salt. In other words, there is no significant coordination or association between the diluent molecules and the lithium cations. The lithium cations remain coordinated with solvent molecules. Thus, although the electrolyte is diluted, there are few or no free solvent molecules in the electrolyte. In any of the foregoing or following embodiments, the diluent may be miscible with the nonaqueous solvent. Due to the solvation structure, embodiments of the disclosed LHCEs facilitate formation of effective SEIs on lithium metal, carbon-based, silicon-based, and carbon/silicon-based electrodes.

In some embodiments, the diluent comprises an organic phosphate, and organic phosphite, or a combination thereof. In some embodiments, the diluent comprises, consists essentially of, or consists of tris(2,2,2-trifluoroethyl) phosphite (TTFEPi), triphenyl phosphite (TPPi), tris(2,2,3,3,3-pentafluoropropyl) phosphate (5F-TPrP), tris(1,1,1,3,3,3-hexafluoropropan-2-yl) phosphate (HFiP), tris(1,1,1,3,3,3-hexafluoropropan-2-yl) phosphite (THFPP), dibutyl phosphite, di-tert-butyl phosphite, or any combination thereof (Table 2). In certain implementations, the diluent comprises, consists essentially of, or consists of TTFEPi.

TABLE 2

| Flame retardant diluent | Chemical structure | Flash Point/° C. |
|---|---|---|
| Tris(2,2,2-trifluoroethyl) phosphite (TTFEPi) | 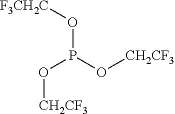 | 113 |
| Triphenyl phosphite (TPPi) | 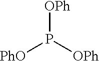 [SMILES: c1ccc(OP(Oc2ccccc2)Oc2ccccc2)cc1] | 210 |
| Tris(2,2,3,3,3- pentafluoropropyl) phosphate (5F-TPrP) | 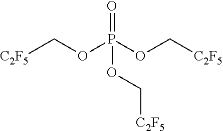 | N.A. |
| Tris(1,1,1,3,3,3- hexafluoropropan-2-yl) phosphate (HFiP) | 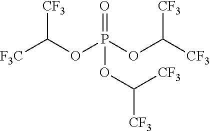 [SMILES: O=P(OC(C(F)(F)F)C(F)(F)F)(OC(C(F)(F)F)C(F)(F)F)OC(C(F)(F)F)C(F)(F)F] | N.A. |
| Tris(1,1,1,3,3,3- hexafluoropropan-2-yl) phosphite (THFPP) | 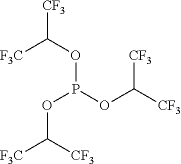 [SMILES: FC(F)(F)C(OP(OC(C(F)(F)F)C(F)(F)F)OC(C(F)(F)F)C(F)(F)F)C(F)(F)F] | N.A. |
| Dibutyl phosphite | 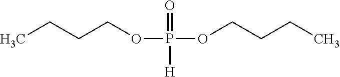 | 118° C.-closed cup |
| Di-tert-butyl phosphite | 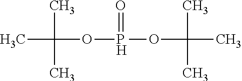 | 163° C. |

In any of the foregoing or following embodiments, the electrolyte may have a lithium salt-nonaqueous solvent-diluent molar ratio of 1:x:y where x=0.1-5.0 and y=0.1-8.0. In some embodiments, x=0.5-5.0, 0.5-4.0, 0.7-3.0, 0.7-2.0, 1.0-2.0, or 1.0-1.5. In some embodiments, y=0.5-5.0, 0.5-4.0, 0.5-3.0,0.5-2.0, 0.7-1.5, or 0.8-1.2. In any of the foregoing or following embodiments, the nonaqueous solvent/diluent (x/y) ratio may be 0.5-2.0, such as 0.7-1.5 or 1.0-1.5.

In some embodiments of the disclosed LHCEs, at least 90%, at least 95%, at least 96%, at least 97%, at least 98%, or at least 99% of the molecules of the nonaqueous solvent are coordinated with lithium cations. In certain embodiments, fewer than 10%, such as fewer than 5%, fewer than 4%, fewer than 3%, or fewer than 2% of the diluent molecules are associated with lithium cations. The degree of coordination can be quantified by any suitable means, such as by calculating the peak intensity ratio of solvent molecules associated with cations and free solvent in Raman spectra or by using NMR spectra.

In any or all of the foregoing or following embodiments, the electrolyte may further comprise an additive. The additive has a different composition than the lithium salt, a different composition than the nonaqueous solvent, and a different composition than the diluent.

Suitable additives comprise carbonates, carboxylates, sultones, sulfates, sulfites, sulfones, lithium salts, dioxazolones, dinitriles, and phosphines. Exemplary additives include, but are not limited to ethylene carbonate (EC), fluoroethylene carbonate (FEC), vinylene carbonate (VC), 4-vinyl-1,3-dioxolan-2-one (vinyl ethylene carbonate, VEC), 4-methylene-1,3-dioxolan-2-one (4-methylene ethylene carbonate, MEC), 4,5-dimethylene-1,3-dioxolan-2-one, allyl acetate, prop-1-ene-1,3-sultone (PES), 1,3,2-dioxathiolane-2-oxide (i.e. ethylene sulfite, ES), 1,3,2-dioxathiolane-2,2-dioxide (i.e. ethylene sulfate, DTD), 1,3,2-dioxathiane-2,2-dioxide (i.e. 1,3-dipropylene sulfate), lithium 2-trifluoromethyl-4,5-dicyanoimidazole (LiTDI), lithium bis(oxalato)borate (LiBOB), lithium difluoro(oxalato)borate (LiDFOB), lithium hexafluorophosphate (LiPF₆), lithium difluorophosphate (LiPO₂F₂), lithium hexafluoroarsenate (LiAsF₆), 3-methyl-1,4,2-dixoazol-5-one (MDO), 2-oxo-1,3,2-dioxathiane, butanedinitrile, pentanedinitrile, hexanedinitrile, tris(pentafluorophenyl) phosphine, 1-methylsulfonylethene, 1-ethenylsulfonylethane, or any combination thereof. In some embodiments, the additive comprises a carbonate. In certain implementations, the additive comprises EC, FEC, or a combination thereof.

The relative amounts of the salt, nonaqueous solvent, diluent, and additive are selected to reduce the cost of materials for the electrolyte, reduce viscosity of the electrolyte, maintain stability of the electrolyte against oxidation at high-voltage cathodes, improve ionic conductivity of the electrolyte, improve wetting ability of the electrolyte (e.g., towards polyolefin separators and electrodes), facilitate formation of an effective SEI layer, or any combination thereof. In some embodiments, the electrolyte has a lithium salt-nonaqueous solvent-diluent-additive molar ratio of 1:x:y:z where x and y are as previously defined, and z=0-1.0. In certain implementations, z is 0.1-0.5, such as 0.1-0.4, 0.1-0.3, or 0.15-0.25. In some embodiments, x+z is 1.0-2.0 or 1.0-1.5, wherein z is 0-0.5 or 0.1-0.5. In any of the foregoing or following embodiments, the electrolyte may have a salt molar concentration of 0.8-1.8 M, such as 0.8 M to 1.5 M or 1.0 M to 1.4 M. In any of the foregoing or following embodiments, the electrolyte may have a salt molar percent of 20 mol % to 40 mol %, such as 25 mol % to 35 mol %.

In any of the foregoing or following embodiments, the lithium salt may comprise, consist essentially of, or consist of LiFSI. In any of the foregoing or following embodiments, the nonaqueous solvent may comprise, consist essentially of, or consist of TMPa, TEPa, TTPa, DMMP, or any combination thereof. In some embodiments, the nonaqueous solvent comprises, consists essentially of, or consists of TMPa. In any of the foregoing or following embodiments, the diluent may comprise, consist essentially of, or consist of TTFEPi, TPPi, 5F-TPrP, HFiP, THFPP, dibutyl phosphite, di-tert-butyl phosphite, or any combination thereof. In some embodiments, the diluent comprises, consists essentially of, or consists of TTFEPi. In any of the foregoing or following embodiments, the additive may comprise, consist essentially of, or consist of a carbonate. In some embodiments, the additive comprises, consists essentially of, or consists of EC, FEC, or a combination thereof.

In one implementation, the electrolyte comprises, consists essentially of, or consists of LiFSI, TMPa, and TTFEPi. In one example, the electrolyte is LiFSI:TMPₐ:TTFEPi (1.0:1.4:1.0 by mol). In an independent implementation, the electrolyte comprises, consists essentially of, or consists of LiFSI, TMPa, TTFEPi, and EC. In one example, the electrolyte is LiFSI:TMPₐ:TTFEPi:EC (1.0:1.2:1.0:0.2 by mol). In another independent implementation, the electrolyte comprises, consists essentially of, or consists of LiFSI, TMPa, TTFEPi, and FEC. In one example, the electrolyte is LiFSI:TMPₐ:TTFEPi:FEC (1.0:1.2:1.0:0.2 by mol).

In any of the foregoing or following embodiments, the electrolyte may have a flash point greater than 75° C., greater than 100° C., greater than 125° C., greater than 150° C., or even greater than 160° C. In some embodiments, the electrolyte comprises LiFSI:TMPₐ:TTFEPi, LiFSI:TMPₐ:TTFEPi:EC, or LiFSI:TMPₐ:TTFEPi:FEC, and the electrolyte has a flash point greater than 160° C.

Compared to the ionic conductivity of conventional lithium salt-organocarbonate electrolytes, relatively low ionic conductivity is an intrinsic feature of LHCEs (Jia et al., ACS Applied Materials & Interfaces 2020, 12:54893-54903; Jia et al., Angew. Chemie Int. Ed. 2021, 60:12999-13006). The low ionic conductivity arises from the relatively low ratio of solvating solvent molecules to lithium salt, resulting in most of the Li existing as non-dissociated ion pairs or ion clusters, and to the relatively high viscosity of the LHCEs, which impedes transportation of charge carriers. In any of the foregoing or following embodiments, the electrolyte may have an ionic conductivity at room temperature (20° C. to 25° C.) of 0.1 mS cm⁻¹ to 5.0 mS cm⁻¹, such as 0.5 mS cm⁻¹ to 3.0 mS cm⁻¹, or 0.5 mS cm⁻¹ to 2.0 mS cm⁻¹, or 0.8 mS cm⁻¹ to 1.0 mS cm⁻¹.

### III. Batteries

Embodiments of the disclosed LHCEs are useful in batteries (e.g., rechargeable batteries), sensors, and supercapacitors. Suitable batteries include, but are not limited to, lithium metal batteries and lithium ion batteries.

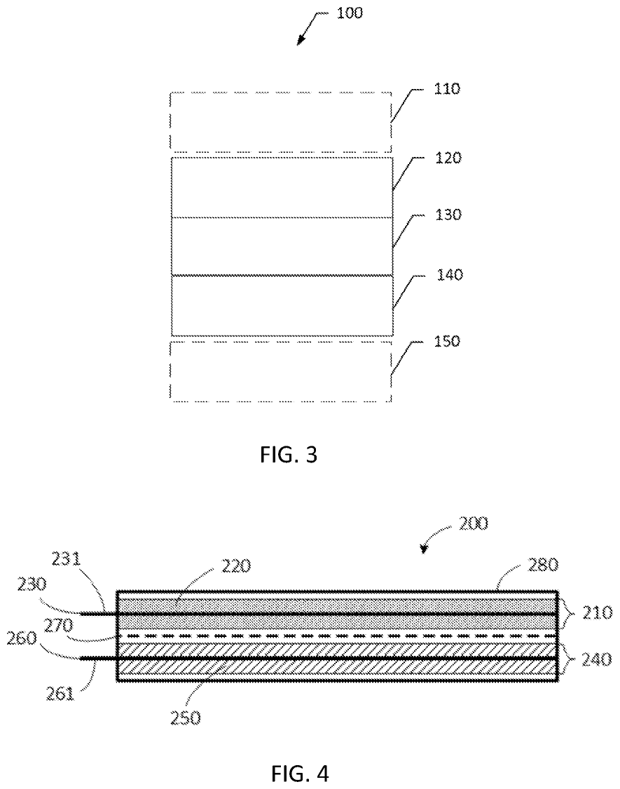

In some embodiments, a rechargeable battery comprises an LHCE as disclosed herein, a cathode, an anode, and optionally a separator. FIG. 3 is a schematic diagram of one exemplary embodiment of a rechargeable battery 100 including a cathode 120, a separator 130 which is infused with an electrolyte as disclosed herein, and an anode 140. In some embodiments, the battery 100 also includes a cathode current collector 110 and/or an anode current collector 150.

In some embodiments the rechargeable battery is a pouch cell. FIG. 4 is a schematic side elevation view of one embodiment of a simplified pouch cell 200. The pouch cell 200 comprises an anode 210 comprising anode material 220 and an anode current collector 230, a cathode 240 comprising cathode material 250 and a cathode current collector 260, a separator 270, and a packaging material defining a pouch 280 enclosing the anode 210, cathode 240, and separator 270. The pouch 280 further encloses an electrolyte as disclosed herein (not shown). The anode current collector 230 has a protruding tab 231 that extends external to the pouch 280, and the cathode current collector 260 has a protruding tab 261 that extends external to the pouch 680.

The current collectors can be a metal or another conductive material such as, but not limited to, nickel (Ni), copper (Cu), aluminum (Al), iron (Fe), stainless steel, or conductive carbon materials. The current collector may be a foil, a foam, or a polymer substrate coated with a conductive material. Advantageously, the current collector is stable (i.e., does not corrode or react) when in contact with the anode or cathode and the electrolyte in an operating voltage window of the battery. The anode and cathode current collectors may be omitted if the anode or cathode, respectively, are free standing, e.g., when the anode is metal or a free-standing film comprising an intercalation material or conversion compound, and/or when the cathode is a free-standing film. By “free-standing” is meant that the film itself has sufficient structural integrity that the film can be positioned in the battery without a support material.

In some embodiments, the anode is lithium metal, an intercalation material, or a conversion compound. The intercalation material or conversion compound may be deposited onto a substrate (e.g., a current collector) or provided as a free-standing film, typically, including one or more binders and/or conductive additives. Suitable binders include, but are not limited to, polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, carboxymethyl cellulose, polyimide, epoxy resin, nylon, and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives).

In some embodiments, the battery is a lithium metal battery and the anode comprises lithium metal. In some implementations, the battery is a lithium ion battery, and the anode, or negative electrode, is a silicon-based, carbon-based (e.g., graphite-, hard, and/or soft carbon-based), or carbon-and silicon-based (e.g., a carbon/silicon composite) anode. By “carbon-based anode” is meant that a majority of the total anode mass is hard and/or soft carbon material, such as at least 70 wt %, at least 80 wt %, or at least 90 wt % carbon material, e.g., graphite, hard carbon, soft carbon, or a mixture thereof. By “silicon-based anode” is meant that the anode contains a certain minimum amount of silicon, such as at least 5%, at least 30%, at least 50 wt %, at least 60 wt %, or at least 90 wt % silicon.

By “carbon/silicon composite-based anode” is meant that a majority of the total anode mass is carbon and silicon, such as at least 70 wt %, at least 80 wt %, or at least 95 wt % of a combination of carbon and silicon. In some examples, the silicon is nano-silicon, carbon coated nano-silicon, or nano-silicon coated on carbon. In some other examples, the silicon is micron sized porous Si with nano-pores or micron sized bulk Si. For instance, the silicon may be carbon-coated nano-silicon, where the silicon is carbon-coated by chemical vapor deposition (CVD) or other approaches. In one embodiment, the silicon is a C/Si composite comprising 10 wt % CVD carbon. In some embodiments, the anode is a silicon/graphite composite anode comprising 10-95 wt % graphite and 5-90 wt % silicon. In certain embodiments, the anode is a silicon/graphite composite anode comprising 70-75 wt % graphite, 5-20 wt % silicon, 0-5 wt % conductive carbon black, and 8-12 wt % binder. In some embodiments, the anode comprises a C/Si composite comprising 5-55 wt % carbon, such as 5-15 wt % carbon; the carbon may be CVD carbon. In some implementations, the composite comprises carbon-coated nano-silicon. In certain embodiments, the anode comprises stabilized porous silicon particles coated with a heterogeneous layer comprising a discontinuous silicon carbide (SiC) coating and a continuous carbon coating. In particular, the particles may comprise a porous silicon particle comprising a plurality of interconnected silicon nanoparticles, interconnected silicon nanoparticles being connected to at least one other silicon nanoparticle, and a plurality of pores defined by the interconnected silicon nanoparticles, the pores including outwardly opening surface pores and internal pores; a heterogeneous layer comprising a discontinuous SiC coating that is discontinuous across a portion of pore surfaces and across a portion of an outer surface of the porous silicon particle, and a continuous carbon coating that covers (i) outer surfaces of the discontinuous SiC coating and (ii) remaining portions of the pore surfaces and the outer surface of the porous silicon particle.

The anode may further include one or more binders and/or conductive additives. Suitable binders include, but are not limited to, polyacrylates (e.g., lithium polyacrylate, LiPAA), polyimides (PI), polyvinyl alcohol, polyvinyl chloride, polyvinyl fluoride, ethylene oxide polymers, polyvinylpyrrolidone, polyurethane, polytetrafluoroethylene, polyvinylidene fluoride, polyethylene, polypropylene, styrene-butadiene rubber, carboxymethyl cellulose, epoxy resin, nylon, and the like. Suitable conductive additives include, but are not limited to, carbon black, acetylene black, Ketjen black, carbon fibers (e.g., vapor-grown carbon fiber), metal powders or fibers (e.g., Cu, Ni, Al), and conductive polymers (e.g., polyphenylene derivatives). In some embodiments, the anode is prelithiated to at least 5% of capacity, at least 10% of capacity, at least 20% of capacity, at least 30% capacity at least 50% of capacity, or up to 100% capacity, such as 0-50% capacity, 10-50% capacity, or 20-30% capacity. Prelithiation may be particularly useful when a cathode with no lithium source is used.

Exemplary cathodes, or positive electrodes, for rechargeable lithium metal and lithium ion batteries include, but are not limited to, Li-rich Li_{1+w}NiₓMn_{y}Co_{z}O₂ (x+y+z+w=1, 0≤w≤0.25), LiNiₓMn_{y}Co_{z}O₂ (NMC, x+y+z=1), LiCoO₂, LiNi_{0.8}Co_{0.15}Al_{0.05}O₂ (NCA), LiNi_{0.5}Mn_{1.5}O₄ spinel, LiMn₂O₄ (LMO), LiFePO₄ (LFP), Li₄₋ₓMₓTi₅O₁₂ (M=Mg, Al, Ba, Sr, or Ta; 0≤x≤1), MnO₂, V₂O₅, V₆O₁₃, LiV₃O₈, LiM^{C1}ₓM^{C2}₁₋ₓPO₄ (M^{C1} or M^{C2}=Fe, Mn, Ni, Co, Cr, or Ti; 0≤x≤1), Li₃V₂₋ₓM¹ₓ(PO₄)₃ (M¹=Cr, Co, Fe, Mg, Y, Ti, Nb, or Ce; 0≤x≤1), LiVPO₄F, LiM^{C1}ₓMC²₁₋ₓO₂ ((M^{C1} and M^{C2} independently are Fe, Mn, Ni, Co, Cr, Ti, Mg, or Al; 0≤x≤1), LiM^{C1}ₓM^{C2}_{y}M^{C3}_{1-x-y}O₂ ((M^{C1}, M^{C2}, and M^{C3} independently are Fe, Mn, Ni, Co, Cr, Ti, Mg, or Al; 0≤x≤1; 0≤y≤1, 0≤x+y≤1), LiMn_{2-y}X_{y}O₄ (X=Cr, Al, or Fe, 0≤y≤1), LiNi_{0.5-y}X_{y}Mn_{1.5}O₄ (X=Fe, Cr, Zn, Al, Mg, Ga, V, or Cu; 0≤y≤0.5), xLi₂MnO₃·(1−x)LiM^{C1}_{y}M^{C2}_{z}M^{C3}_{1-y-z}O₂ (M^{C1}, M^{C2}, and M^{C3} independently are Mn, Ni, Co, Cr, Fe, or mixture thereof; x=0.3-0.5; y≤0.5; z≤ 0.5), Li₂M²SiO₄ (M²=Mn, Fe, or Co), Li₂M²SO₄ (M²=Mn, Fe, or Co), LiM²SO₄F (M²=Fe, Mn, or Co), Li₂₋ₓ(Fe_{1-y}Mn_{y})P₂O₇ (0≤x≤1; 0≤y≤1), metal oxides such as Cr₃O₈ and Cr₂O₅, metal fluorides such as FeFₓ (x=2˜3) and CuF₂, a carbon/sulfur composite, or an air electrode (e.g., a carbon-based electrode comprising graphitic carbon and, optionally, a metal catalyst such as Ir, Ru, Pt, Ag, or Ag/Pd). In an independent embodiment, the cathode may be a lithium conversion compound, such as Li₂O₂, Li₂O, Li₂S, or FeFₓ (x=2˜3). In some examples, the cathode comprises LiNiₓMn_{y}Co_{z}O₂ where x≥0.6 (NMC) or LiNiₓMg_{y}Ti_{1-x-y}O₂ where 0.9≤x<1 (NMT; e.g., LiNi_{0.96}Mg_{0.02}Ti_{0.02}O₂).

The separator may be glass fiber, a porous polymer film (e.g., polyethylene- or polypropylene-based material) with or without a ceramic coating, a porous polyimide film, a composite (e.g., a porous film of inorganic particles and a binder), or a combination thereof. One exemplary polymeric separator is a Celgard® K1640 polyethylene (PE) membrane. Another exemplary polymeric separator is a Celgard® 2500polypropylene membrane. Another exemplary polymeric separator is a Celgard® 3501 surfactant-coated polypropylene membrane. The separator may be infused with an electrolyte, as disclosed herein.

In some embodiments, a battery includes a lithium metal, carbon-based, silicon-based, or carbon/silicon composite-based anode, a cathode suitable for a lithium metal or lithium ion battery, a separator, and an LHCE comprising (a) a lithium salt, (b) a nonaqueous solvent comprising a flame retardant, wherein the lithium salt is soluble in the solvent, and (c) a diluent having a flash point greater than 90° C., wherein the lithium salt has a solubility in the diluent at least 10 times less than a solubility of the lithium salt in the nonaqueous solvent. In certain embodiments, the LHCE further comprises (d) an additive having a different composition than the lithium salt, a different composition than the nonaqueous solvent, and a different composition than the diluent. In any of the foregoing or following embodiments, the electrolyte may have a lithium salt-nonaqueous solvent-diluent molar ratio of 1:x:y where x=0.1-5.0 and y=0.1-8.0, or a lithium salt-nonaqueous solvent-diluent-additive molar ratio of 1:x:y:z where x=0.1-5.0, y=0.1-8.0, and z=0-1.0. In one embodiment, the electrolyte comprises, consists essentially of, or consists of LiFSI, TMPa, and TTFEPi. In an independent embodiment, the electrolyte comprises, consists essentially of, or consists of LiFSI, TMPa, TTFEPi, and EC. In another independent embodiment, the electrolyte comprises, consists essentially of, or consists of LiFSI, TMPa, TTFEPi, and FEC.

In one embodiment, the battery comprises a lithium metal anode, and the electrolyte comprises LiFSI, TMPa, and TTFEPi. In an independent embodiment, the battery comprises a carbon-based (e.g., graphite) anode, and the electrolyte comprises LiFSI, TMPa, TTFEPi, and, optionally, EC, FEC, or a combination thereof. In some implementations, the cathode comprises LiFePO₄.

In any of the foregoing or following embodiments, the battery may be charged and/or discharged at a C rate from C/10 to 5C, such as rate from C/5 to 3C (in some examples, 1C corresponds to 1.5 mA cm⁻²). Alternatively, the battery may be charged and/or discharged at a current density of 0.15-5 mA cm⁻², such as 0.3-1 mA cm⁻² or 0.3-0.5 mA cm⁻². The batteries may be charged and discharged within the voltage range of 2.8-3.9 V. The battery may be charged and discharged at different rates.

In some embodiments, an LMB including an LHCE as disclosed herein has a capacity retention of at least 90%, at least 95%, at least 97%, at least 98%, or at least 99% after 80 cycles. Whereas an LMB including a conventional electrolyte (1.0 M LiPF₆/EC-EMC (3:7 wt.)+2 wt % VC) may have an average CE of less than 70% (after 5-10 formation cycles), an LMB including an LHCE as disclosed herein may have a dramatically higher average CE, such as a CE greater than 95%, such as greater than 98%, or greater than 98.5% after 5-10 formation cycles. In one example, an LMB including a conventional electrolyte exhibited rapidly increasing polarization voltage after approximately 70 hours, whereas an LMB including an LHCE as disclosed herein exhibited a cycle life of at least 275 hours.

In some embodiments, an LIB including a graphite-based anode and an LHCE as disclosed herein exhibits long-term cycling performance with a capacity retention of at least 60% after 600 cycles. Although neither TMPa nor TTFEPi has been found to be capable of forming an effective SEI on a graphite-based anode when included as flame retardants in conventional LiPF₆-organocarbonate electrolytes, embodiments of the disclosed LHCEs with their unique solvation structure promote participation of anions in the SEI formation, thereby facilitating long-term cycling stability in a safe, nonflammable electrolyte.

### IV. Representative Aspects

Certain representative aspects are exemplified in the following numbered paragraphs.
1. An electrolyte, comprising: a lithium salt; a nonaqueous solvent comprising a flame retardant, wherein the lithium salt is soluble in the nonaqueous solvent; and a diluent having a flash point greater than 90° C., wherein the lithium salt has a solubility in the diluent at least 10 times less than a solubility of the lithium salt in the nonaqueous solvent.
2. The electrolyte of paragraph 1, wherein the nonaqueous solvent has a flash point greater than 60° C.
3. The electrolyte of paragraph 1 or paragraph 2, having a lithium salt-nonaqueous solvent-diluent molar ratio of 1:x:y where x=0.1-5.0 and y=0.1-8.0.
4. The electrolyte of paragraph 3, wherein x=1.0-1.5 and y=0.8-1.2.
5. The electrolyte of any one of paragraphs 1-4, wherein the lithium salt comprises lithium bis(fluorosulfonyl)imide (LiFSI), lithium bis(trifluoromethanesulfonyl)imide (LiTFSI), lithium (fluorosulfonyl)(trifluoromethylsulfonyl)imide (LiFTFSI), lithium bis(pentafluoroethanesulfonyl)imide (LiBETI), lithium trifluoromethanesulfonate (LiTf, LiCF₃SO₃), LiPF₆, LiAsF₆, LiBF₄, LiClO₄, lithium bis(oxalato)borate (LiBOB), lithium difluoro(oxalato)borate (LiDFOB), LiI, LiBr, LiCl, LiSCN, LiNO₃, LiNO₂, Li₂SO₄, or any combination thereof.
6. The electrolyte of any one of paragraphs 1-5, wherein the flame retardant comprises an organic phosphate, an organic phosphonate, an organic phosphazene, an organic phosphoramide, or any combination thereof.
7. The electrolyte of paragraph 6, wherein the flame retardant comprises trimethyl phosphate (TMPa), triethyl phosphate (TEPa), triphenyl phosphate (TPPa), tributyl phosphate, tris(2,2,2-trifluoroethyl) phosphate, bis(2,2,2-trifluoroethyl) methyl phosphate, dimethyl methylphosphonate (DMMP), diethyl ethylphosphonate, diethyl phenylphosphonate, bis(2,2,2-trifluoroethyl) methylphosphonate, hexamethylphosphazene, hexamethylphosphoramide, or any combination thereof.
8. The electrolyte of paragraph 7, wherein the flame retardant comprises TMPa, TEPa, TTPa, DMMP, or any combination thereof.
9. The electrolyte of any one of paragraphs 1-8, wherein the nonaqueous solvent consists essentially of the flame retardant.
10. The electrolyte of any one of paragraphs 1-9, wherein the diluent comprises an organic phosphate, an organic phosphite, or a combination thereof.
11. The electrolyte of paragraph 10, wherein the diluent comprises tris(2,2,2-trifluoroethyl) phosphite (TTFEPi), triphenyl phosphite (TPPi), tris(2,2,3,3,3-pentafluoropropyl) phosphate (5F-TPrP), tris(1,1,1,3,3,3-hexafluoropropan-2-yl) phosphate (HFiP), tris(1,1,1,3,3,3-hexafluoropropan-2-yl) phosphite (THFPP), dibutyl phosphite, di-tert-butyl phosphite, or any combination thereof.
12. The electrolyte of any one of paragraphs 1-11, further comprising an additive having a different composition than the lithium salt, a different composition than the nonaqueous solvent, and a different composition than the diluent.
13. The electrolyte of any one of paragraphs 1-12, having a lithium salt-nonaqueous solvent-diluent-additive molar ratio of 1:x:y:z where x=0.1-5.0, y=0.1-8.0, and z=0-1.0.
14. The electrolyte of paragraph 13, wherein x=1.0-1.5, y=0.8-1.2, and z=0.1-0.5.
15. The electrolyte of any one of paragraphs 12-14, wherein the additive comprises ethylene carbonate (EC), fluoroethylene carbonate (FEC), vinylene carbonate (VC), 4-vinyl-1,3-dioxolan-2-one (vinyl ethylene carbonate, VEC), 4-methylene-1,3-dioxolan-2-one (4-methylene ethylene carbonate, MEC), 4,5-dimethylene-1,3-dioxolan-2-one, allyl acetate, prop-1-ene-1,3-sultone (PES), 1,3,2-dioxathiolane-2-oxide ethylene sulfite, ES), 1,3,2-dioxathiolane-2,2-dioxide (ethylene sulfate, DTD), 1,3,2-dioxathiane-2,2-dioxide (1,3-dipropylene sulfate), lithium 2-trifluoromethyl-4,5-dicyanoimidazole (LiTDI), lithium bis(oxalato)borate (LiBOB), lithium difluoro(oxalato)borate (LiDFOB), LiPF₆, LiPO₂F₂, LiAsF₆, 3-methyl-1,4,2-dixoazol-5-one (MDO), 2-oxo-1,3,2-dioxathiane, butanedinitrile, pentanedinitrile, hexanedinitrile, tris(pentafluorophenyl) phosphine, 1-methylsulfonylethene, 1-ethenylsulfonylethane, or any combination thereof.
16. The electrolyte of paragraph 15, wherein the additive comprises EC, FEC, or a combination thereof.
17. The electrolyte of any one of paragraphs 1-16, comprising LiFSI, TMPa, and TTFEPi.
18. The electrolyte of paragraph 17, further comprising EC, FEC, or a combination thereof.
19. The electrolyte of any one of paragraphs 12-18, consisting essentially of: the lithium salt; the nonaqueous solvent; the diluent; and optionally, the additive.
20. The electrolyte of any one of paragraphs 1-19, consisting essentially of: LiFSI, TMPa, and TTFEPi; or LiFSI, TMPa, TTFEPi, and EC; or LiFSI, TMPa, TTFEPi, and FEC.
21. The electrolyte of any one of paragraphs 1-20, having a flash point greater than 160° C.
22. An electrolyte, comprising: a lithium salt; a nonaqueous solvent comprising a flame retardant, the flame retardant comprising an organic phosphate, an organic phosphonate, an organic phosphazene, an organic phosphoramide, or a combination thereof, wherein the nonaqueous solvent has a flash point greater than 60° C. and the lithium salt is soluble in the nonaqueous solvent; and a diluent comprising having a flash point greater than 90° C., the diluent comprising an organic phosphate, an organic phosphite, or a combination thereof, wherein the lithium salt has a solubility in the diluent at least 10 times less than a solubility of the lithium salt in the nonaqueous solvent, wherein the electrolyte has a lithium salt-nonaqueous solvent-diluent molar ratio of 1:x:y where x=0.1-5.0 and y=0.1-8.0.
23. The electrolyte of paragraph 22, comprising: LiFSI; TMPa, TEPa, TTPa, DMMP, or any combination thereof; and TTFEPi, TPPi, 5F-TPrP, HFiP, THFPP, dibutyl phosphite, di-tert-butyl phosphite, or any combination thereof, wherein the electrolyte has a flash point greater than 160° C.
24. The electrolyte of paragraph 23, consisting essentially of: LiFSI; TMPa, TEPa, TTPa, DMMP, or any combination thereof; and TTFEPi, TPPi, 5F-TPrP, HFiP, THFPP, dibutyl phosphite, di-tert-butyl phosphite, or any combination thereof.
25. The electrolyte of paragraph 22 or paragraph 23, further comprising an additive having a different composition than the lithium salt, a different composition than the nonaqueous solvent, and a different composition than the diluent, wherein the electrolyte has a lithium salt-nonaqueous solvent-diluent-additive molar ratio of 1:x:y where x=0.1-5.0, y=0.1-8.0. and z=0-1.0.
26. The electrolyte of paragraph 25, wherein the additive comprises EC, FEC, or a combination thereof.
27. The electrolyte of paragraph 25 or paragraph 26, consisting essentially of: LiFSI; TMPa, TEPa, TTPa, DMMP, or any combination thereof; TTFEPi, TPPi, 5F-TPrP, HFiP, THFPP, dibutyl phosphite, di-tert-butyl phosphite, or any combination thereof; and the additive.
28. The electrolyte of paragraph 23, comprising (i) LiFSI, (ii) TMPa, (iii) TTFEPi, and (iv) EC, FEC, or a combination thereof, in a lithium salt-nonaqueous solvent-diluent-additive molar ratio of 1:x:y:z wherein x=1.1-1.5, y=0.9-1.1, and z=0-0.3.
29. The electrolyte of paragraph 28, consisting essentially of (i) the LiFSI, (ii) the TMPa, (iii) the TTFEPi, and (iv) the EC, FEC, or a combination thereof.
30. A battery, comprising: an electrolyte according to any one of paragraphs 1-29; an anode, wherein the anode is lithium metal, a carbon-based anode, a silicon-based anode, or a silicon- and carbon-based anode; and a cathode.
31. The battery of paragraph 30, wherein the cathode comprises Li_{1+w}NiₓMn_{y}Co_{z}O₂ (x+y+z+w=1, 0≤w≤0.25), LiNiₓMn_{y}CO_{z}O₂ (x+y+z=1), LiCoO₂, LiNi_{0.8}Co_{0.15}Al_{0.05}O₂, LiNi_{0.5}Mn_{1.5}O₄ spinel, LiMn₂O₄, LiFePO₄, Li₄₋ₓMₓTi₅O₁₂ (M=Mg, Al, Ba, Sr, or Ta; 0≤x≤1), MnO₂, V₂O₅, V₆O₁₃, LiV₃O₈, LiM^{C1}ₓM^{C2}₁₋ₓPO₄ (M^{C1} or M^{C2}=Fe, Mn, Ni, Co, Cr, or Ti; 0≤x≤1), Li₃V₂₋ₓM¹ₓ(PO₄)₃ (M¹=Cr, Co, Fe, Mg, Y, Ti, Nb, or Ce; 0≤x≤1), LiVPO₄F, LiM^{C1}ₓM^{C2}₁₋ₓO₂ ((M^{C1} and M^{C2} independently are Fe, Mn, Ni, Co, Cr, Ti, Mg, or Al; 0≤x≤1), LiM^{C1}ₓM^{C2}_{y}M^{C3}_{1-x-y}O₂ ((M^{C1}, M^{C2}, and M^{C3} independently are Fe, Mn, Ni, Co, Cr, Ti, Mg, or Al; 0≤x≤1; 0≤y≤1), LiMn_{2-y}X_{y}O₄ (X=Cr, Al, or Fe, 0≤y≤1), LiNi_{0.5-y}X_{y}Mn_{1.5}O₄ (X=Fe, Cr, Zn, Al, Mg, Ga, V, or Cu; 0≤y<0.5), xLi₂MnO₃·(1−x)LiM^{C1}_{y}M^{C2}_{z}M^{C3}_{1-y-z}O₂ (M^{C1}, M^{C2}, and M^{C3} independently are Mn, Ni, Co, Cr, Fe, or mixture thereof: x=0.3-0.5; y≤0.5; z≤0.5), Li₂M²SiO₄ (M²=Mn, Fe, or Co), Li₂M²SO₄ (M²=Mn, Fe, or Co), LiM²SO₄F (M²=Fe, Mn, or Co), Li₂₋ₓ(Fe_{1-y}Mn_{y})P₂O₇ (0≤y≤1), metal oxides, metal fluorides, a carbon/sulfur composite, or an air electrode.
32. The battery of paragraph 30 or paragraph 31, wherein: the electrolyte consists essentially of LiFSI, TMPa, and TTFEPi; and the anode is lithium metal.
33. The battery of paragraph 30 or paragraph 31, wherein: the electrolyte consists essentially of LiFSI, TMPa, TTFEPi, and EC, FEC, or a combination thereof; and the anode is a carbon-based anode, a silicon-based anode, or a silicon-and carbon-based anode.
34. The battery of paragraph 32 or paragraph 33, wherein the cathode comprises LiFePO₄.

### V. Examples

### Chemical and Materials

The electrolyte formulae are summarized in Table 3. A conventional LiPF₆-organocarbonate electrolyte was selected as the baseline electrolyte (E-baseline). Three LHCEs were prepared: safe electrolyte-no additive (SE-NA), safe electrolyte-ethylene carbonate (SE-E), and safe electrolyte-fluoroethylene carbonate (SE-F).

TABLE 3

| Code | Electrolyte formula |
|---|---|
| E-Baseline | 1.0M LiPF₆/EC-EMC (3:7 wt.) + 2 wt. % VC |
| SE-NA | LiFSI:TMPa:TTFEPi = 1.0:1.4:1.0 by mol. |
| SE-E | LiFSI:TMPa:EC:TTFEPi = 1.0:1.2:0.2:1.0 by mol. |
| SE-F | LiFSI:TMPa:FEC:TTFEPi = 1.0:1.2:0.2:1.0 by mol. |

### Coin Cell Assembly and Electrochemical Tests

Laminates of graphite (Gr) and LiFePO₄ (LFP) electrodes were obtained from the Cell Analysis, Modeling, and Prototyping (CAMP) Facility at Argonne National Laboratory (ANL) and their corresponding areal capacities were 1.8 and 1.5 mAh cm⁻², respectively. Disks of Gr (15.0 mm in diameter) and LFP (12.7 mm in diameter) were punched, dried at 110° C. under vacuum for at least 12 h, and then transferred into an argon-filled glovebox. CR2032 coin cell kits were obtained from MTI Corporation (Richmond, CA). Each coin cell was assembled with a piece of LFP disk, a piece of polyethylene separator (Asahi Hi-Pore, Japan), a piece of Gr disk, and 50 μL of the electrolyte. To avoid the anodic corrosion of stainless steel (SS) at high voltages, the aluminum (Al)-clad positive case and an additional Al foil of 19.0 mm diameter placed in between the positive cathode disk and the Al-clad positive case were used for all the cells with the LFP cathode. Li∥Li and Li∥Cu cells were assembled in a similar manner with the exceptions that the regular stainless steel positive cases were used and the electrolyte content in all LMBs was increased to 75 μL. After cell assembly, the cells were placed in a temperature chamber (TestEquity TEC1) of 25° C., connected to a LANDT battery testing system (CT2001A, Landt Instruments, Vestal, NY) and rested for 12 h. All the electrochemical tests were performed at a temperature of 25.0±0.1° C.

### Example 1

### Flammability and Flash Points

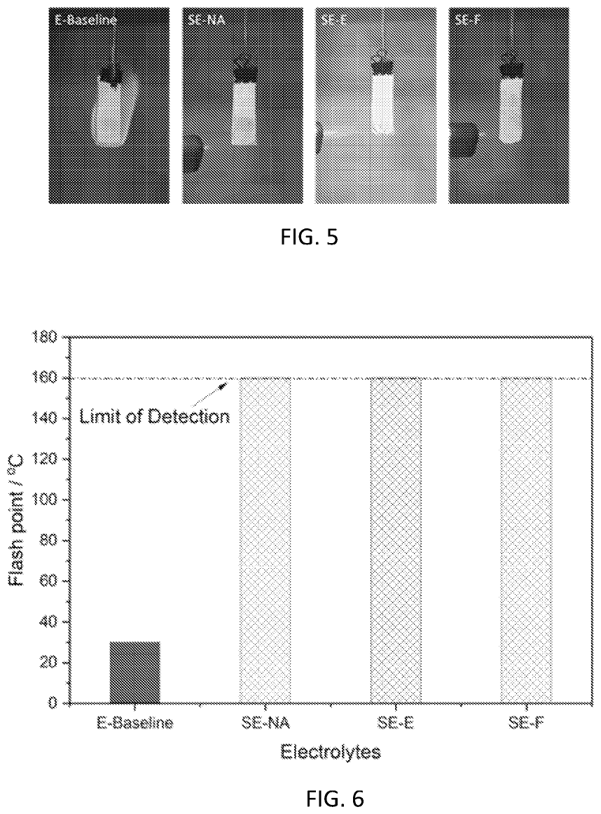

To verify that using flame retardants (FRs) as both the solvating solvent and the diluent significantly suppresses flammability of the LHCEs, ignition measurements were performed for the E-baseline and LHCEs. As shown in FIG. 5, E-Baseline was readily ignited by an external heating source (a butane torch), and the combustion was self-sustained. In comparison, none of the LHCEs could be ignited by the butane torch. It can be concluded that LHCEs exhibit excellent resistance towards flame since they are mainly comprised of FR.

The flash points of the studied electrolytes are summarized in FIG. 6. The flash point of the conventional LiPF₆-organocarbonate electrolyte is merely 30° C. Based on the criteria released by the National Fire Protection Association of United States, E-Baseline should be categorized as a flammable liquid since its flash point is lower than the threshold value of 37.8° C. In contrast, the flash points of the SE-NA, SE-E and SE-F exceeded the limit of detection of the flash point determination device (160° C.). During the measurement, the flames of the device were extinguished by the vapor of the safe LHCEs, indicating superior safety properties of the safe LHCEs.

### Example 2

### Ionic Conductivity Dependence on Temperature

Ionic conductivity is an important parameter of an electrolyte since it influences the power input/output of LIBs and LMBs. The dependence of ionic conductivities of studied electrolytes on temperature was evaluated with a BioLogic MCS conductimeter (BioLogic, France). The cells comprising the studied electrolytes were heated up to 60.0° C. After reaching thermal equilibrium, the temperature of the cells was decreased stepwise to −40.0° C. at a step length of −5° C./step. At each temperature, the cell was held under thermostatic conditions for 15 min to reach thermal equilibrium, after which the ionic conductivities were recorded.

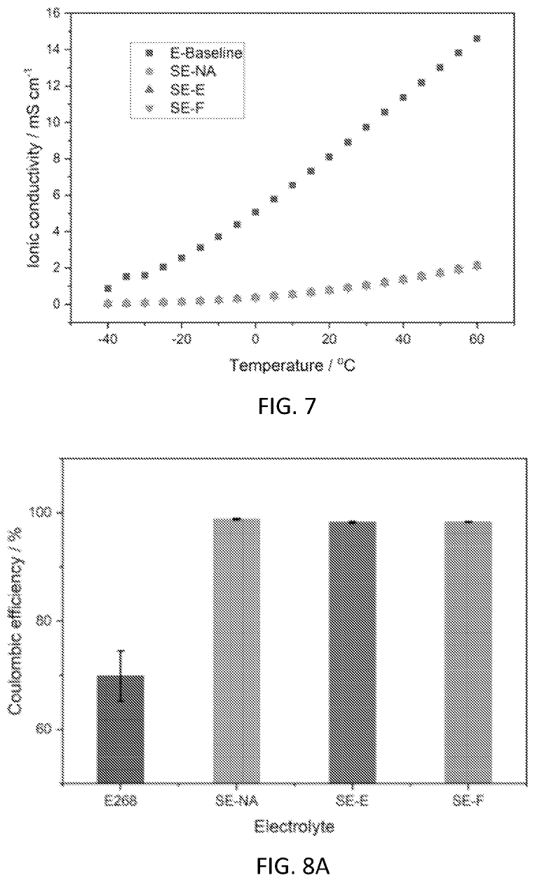

FIG. 7 exhibits the dependence of ionic conductivities of the studied electrolytes on temperature. As illustrated in FIG. 7, the ionic conductivity of the E-baseline was significantly higher than the safe electrolytes. At the temperature of 25.0° C., the ionic conductivity of the baseline electrolyte was determined to be 8.92 mS cm⁻¹, being significantly higher than those of safe LHCEs (SE-NA: 0.95 mS cm⁻¹; SE-E: 0.90 mS cm⁻¹ and SE-F: 0.90 mS cm⁻¹). Due to the relative scarcity of solvating solvent to Li salt (TMPa to LiFSI=1.4:1.0 by mol.), most of the Li exists as non-dissociated ion pairs or ion clusters. In addition, the relatively high viscosity of safe LHCEs also impedes the facile transportation of charge carriers. Both factors contribute to a relatively low ionic conductivity of the safe LHCEs. The relatively low ionic conductivity is an intrinsic feature of LHCEs (Jia et al., ACS Applied Materials & Interfaces 2020, 12:54893-54903; Jia et al., Angew. Chemie Int. Ed. 2021, 60:12999-13006).

After substituting part of the solvating solvent in SE-NA with equivalent mole of cyclic organocarbonate (EC in SE-E, FEC in SE-F). the ionic conductivity was slightly decreased. The reason behind such phenomenon can be assigned to the weaker solvation capability per molecule of EC or FEC than that of TMPa.

### Example 3

Compatibility with Lithium Metal Electrode

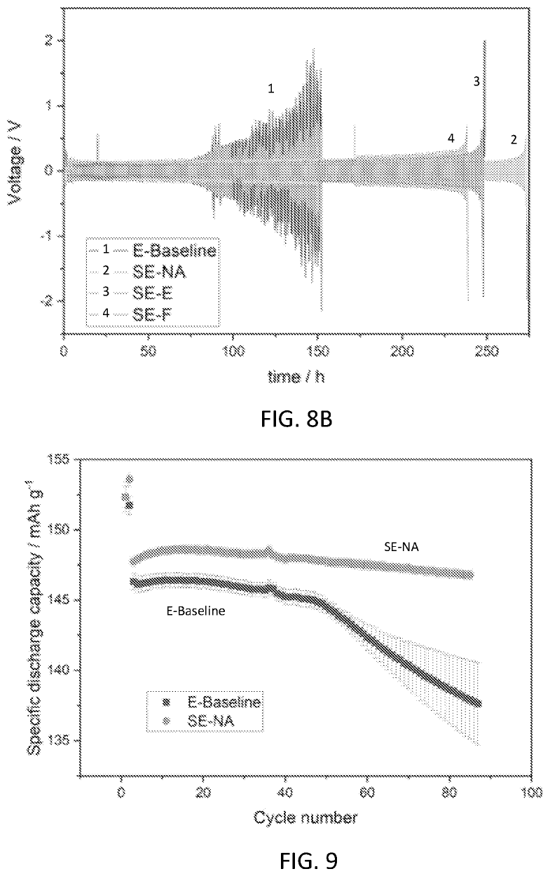

Li∥Cu and Li∥Li cells were assembled. The Li∥Cu cells were employed to measure the CE of repeated Li deposition and stripping on a Cu substrate. The formation cycle was comprised of the Li deposition on Cu electrode at the current density of 0.5 mA cm⁻² for 10 h followed by the stripping of Li to 1.5 V at the current density of 0.5 mA cm⁻². After the formation cycle, the Cu substrates were deposited with 5 mAh cm⁻² of Li again (0.5 mA cm⁻² for 10 h). Subsequently, the cells were charged (for Li stripping) and discharged (for Li deposition) for nine cycles, in which both charge and discharge cycles were performed at 0.5 mA cm⁻² for 2 h. Finally, the cells were fully charged to 1.5 V to strip all Li on the Cu substrate. The average Li CE was calculated using the following equation:

$$CE = \frac{9 {Q}_{C} + {Q}_{S}}{9 {Q}_{C} + {Q}_{T}}$$

where Q_{T} is the amount of charge that is used to deposit Li onto the Cu substrate first as a Li reservoir, Q_{C} is the small amount of charge used to cycle Li between working and counter electrodes for n cycles, and Q_{S} is the final stripping charge (Q_{S}), corresponding to the quantity of Li remaining alter n cycles. The average CEs of Li∥Cu cells using the studied electrolytes are summarized in FIG. 8A. When the conventional E-baseline was used, the average CE of Li∥Cu cells was merely 69.9%. In comparison, cells using SE-NA, SE-E and SE-F exhibited dramatically increased average CEs of 98.9%, 98.4% and 98.3%.

In addition to the average CE evaluations, the compatibilities between the studied electrolytes and Li electrodes were studied by repeated Li plating/stripping in Li∥Li symmetric cells. When the polarization voltage exceeded 2 V, the evaluation was automatically terminated by the cell tester. As shown in FIG. 8B, the cell using E-baseline exhibited rapidly increasing polarization voltage after approximately 70 h. The evaluation was terminated after about 150 h. In comparison, the cell using SE-NA exhibited a cycle life of 275 h, which was almost twice as that of E-Baseline cell. Evidently, the SE-NA electrolyte is superior to the E-Baseline in terms of Li compatibility. The addition of an electrolyte additive such as EC or FEC into SE-NA led to a shortened cycle life of Li∥Li cells. Without wishing to be bound by a particular theory of operation, the shortened cycle life can be probably attributed to the high reactivity between the electrolyte additive and metallic Li. Nevertheless, all of the safe LHCEs exhibited significantly better compatibility with Li metal electrode than the E-Baseline electrolyte.

### Example 4

Electrochemical Performance in Li∥LiFePO₄ (LFP) Cells

As confirmed by the previous characterizations, the safe LHCEs exhibit better compatibility with metallic Li electrodes than the conventional electrolyte. Among all the studied electrolytes, the safe electrolyte with no additive (SE-NA) showed the best compatibility with metallic Li. To verify the applicability of SE-NA in practical cell chemistry, Li∥LFP cells were assembled and evaluated. E-baseline was employed as the benchmark electrolyte.

After two formation cycles at C/10, the cells were charged at C/5 and discharged at C/3 at 25° C. in the voltage range of 2.8-4.0 V, where 1C=1.5 mA cm⁻². As shown in FIG. 9, the average specific capacity of Li∥LFP cells using SE-NA was 147.7 mAh g⁻¹, being slightly higher than that of E-baseline cells (146.3 mAh g⁻¹). After approximately 50 charge/discharge cycles, cells using E-baseline exhibited a rapidly accelerated capacity decay. Without wishing to be bound by a particular theory of operation, the accelerated capacity delay may be attributable to the depletion of electrolyte and/or the “hyperplasia” of SEI on metallic Li. In comparison, cells using SE-NA exhibited only negligible capacity decay after more than 80 charge/discharge cycles, indicating that SE-NA can achieve superior cycling performance to E-baseline in Li∥LFP cells. The superior cycling performance is attributed to the superior compatibility between SE-NA and metallic Li electrode, as confirmed in Example 3.

### Example 5

### Electrochemical Performance in Gr∥LFP Cells

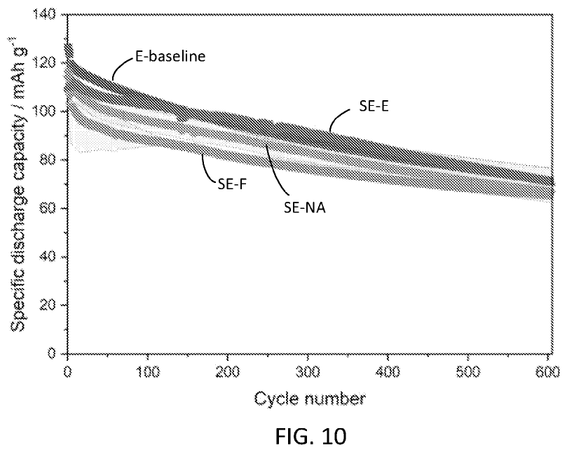

The long-term cycling performance of Gr∥LFP cells was evaluated. The formation procedure comprised one charge/discharge cycle at the C-rate of C/20 and two charge/discharge cycles under the C-rate of C/10, where 1C=1.5 mA cm⁻². After the formation cycles, the cells were charged/discharged for 600 cycles under the C-rate of C/5. After the formation cycles, the average specific discharge capacity of the cells including E-baseline was 119.7 mAh g⁻¹, being higher than those of SE-NA (110.3 mAh g⁻¹), SE-E (110.9 mAh g⁻¹) and SE-F (102.4 mAh g⁻¹) cells (FIG. 10). After 600 cycles, the specific capacities of cells using E-baseline, SE-NA, SE-E, and SE-F declined to 71.5, 67.0, 70.8 and 66.0 mAh g⁻¹, corresponding to the capacity retentions of 59.7%, 60.7%, 63.8% and 64.4% respectively.

According to literature, neither TMPa nor TTFEPi is capable of forming an effective SEI on Gr without the unique solvation structures of LHCEs. On the contrary, TMPa and TTFEPi are considered to interfere with the formation of effective SEI on Gr when they are used as FRs in conventional LiPF₆-organocarbonate electrolytes. However, when TMPa and TTFEPi are combined at a proper ratio, the difference in their coordination ability towards lithium salt creates the unique solvation structure of LHCEs, which promotes the participation of anions in the SEI formation. Consequently, their incapability of forming effective SEI on Gr is resolved. As shown in FIG. 10, the Gr∥LFP cells can be charged/discharged for more than 600 cycles, indicating the excellent efficacy of SEIs formed in the safe LHCEs. It can be concluded that the disclosed LHCEs are highly compatible with Gr electrodes.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. An electrolyte, comprising:
a lithium salt;
a nonaqueous solvent comprising a flame retardant, wherein the lithium salt is soluble in the nonaqueous solvent; and
a diluent having a flash point greater than 90° C., the diluent comprising an organic phosphate, an organic phosphite, or a combination thereof, wherein the lithium salt has a solubility in the diluent at least 10 times less than a solubility of the lithium salt in the nonaqueous solvent.

2. The electrolyte of claim 1, wherein:
(i) the nonaqueous solvent has a flash point greater than 60° C.; or
(ii) the electrolyte has a flash point greater than 160° C.; or
(iii) the electrolyte has a lithium salt-nonaqueous solvent-diluent molar ratio of 1:x:y where x=0.1-5.0 and y=0.1-8.0; or
(iii) both (i) and (ii).

3. (canceled)

4. The electrolyte of claim 1, wherein the lithium salt comprises lithium bis(fluorosulfonyl)imide (LiFSI), lithium bis(trifluoromethanesulfonyl)imide (LiTFSI), lithium (fluorosulfonyl)(trifluoromethylsulfonyl)imide (LiFTFSI), lithium bis(pentafluoroethanesulfonyl)imide (LiBETI), lithium trifluoromethanesulfonate (LiTf, LiCF₃SO₃), LiPF₆, LiAsF₆, LiBF₄, LiClO₄, lithium bis(oxalato)borate (LiBOB), lithium difluoro(oxalato)borate (LiDFOB), LiI, LiBr, LiCl, LiSCN, LiNO₃, LiNO₂, Li₂SO₄, or any combination thereof.

5. The electrolyte of claim 1, wherein the flame retardant comprises an organic phosphate, an organic phosphonate, an organic phosphazene, an organic phosphoramide, or any combination thereof.

6. The electrolyte of claim 5, wherein the flame retardant comprises trimethyl phosphate (TMPa), triethyl phosphate (TEPa), triphenyl phosphate (TPPa), tributyl phosphate, tris(2,2,2-trifluoroethyl) phosphate, bis(2,2,2-trifluoroethyl) methyl phosphate, dimethyl methylphosphonate (DMMP), diethyl ethylphosphonate, diethyl phenylphosphonate, bis(2,2,2-trifluoroethyl) methylphosphonate, hexamethylphosphazene, hexamethylphosphoramide, or any combination thereof.

7. (canceled)

8. The electrolyte of claim 1, wherein the diluent comprises tris(2,2,2-trifluoroethyl) phosphite (TTFEPi), triphenyl phosphite (TPPi), tris(2,2,3,3,3-pentafluoropropyl) phosphate (5F-TPrP), tris(1,1,1,3,3,3-hexafluoropropan-2-yl) phosphate (HFiP), tris(1,1,1,3,3,3-hexafluoropropan-2-yl) phosphite (THFPP), dibutyl phosphite, di-tert-butyl phosphite, or any combination thereof.

9. The electrolyte of claim 1, further comprising an additive having a different composition than the lithium salt, a different composition than the nonaqueous solvent, and a different composition than the diluent.

10. The electrolyte of claim 1, having a lithium salt-nonaqueous solvent-diluent-additive molar ratio of 1:x:y:z where x=0.1-5.0, y=0.1-8.0, and z=0-1.0.

11. The electrolyte of claim 9, wherein the additive comprises ethylene carbonate (EC), fluoroethylene carbonate (FEC), vinylene carbonate (VC), 4-vinyl-1,3-dioxolan-2-one (VEC), 4-methylene-1,3-dioxolan-2-one (4-methylene ethylene carbonate, MEC), 4,5-dimethylene-1,3-dioxolan-2-one, allyl acetate, prop-1-ene-1,3-sultone (PES), 1,3,2-dioxathiolane-2-oxide ethylene sulfite, ES), 1,3,2-dioxathiolane-2,2-dioxide (ethylene sulfate, DTD), 1,3,2-dioxathiane-2,2-dioxide (1,3-dipropylene sulfate), lithium 2-trifluoromethyl-4,5-dicyanoimidazole (LiTDI), lithium bis(oxalato)borate (LiBOB), lithium difluoro(oxalato)borate (LiDFOB), LiPF₆, LiPO₂F₂, LiAsF₆, 3-methyl-1,4,2-dixoazol-5-one (MDO), 2-oxo-1,3,2-dioxathiane, butanedinitrile, pentanedinitrile, hexanedinitrile, tris(pentafluorophenyl)phosphine, 1-methylsulfonylethene, 1-ethenylsulfonylethane, or any combination thereof.

12. The electrolyte of claim 1, comprising:
LiFSI;
TMPa, TEPa, TTPa, DMMP, or any combination thereof; and
TTFEPi, TPPi, 5F-TPrP, HFiP, THFPP, dibutyl phosphite, di-tert-butyl phosphite, or any combination thereof.

13. The electrolyte of claim 12, further comprising an additive, wherein the additive is EC, FEC, or a combination thereof.

14. The electrolyte of claim 9, consisting essentially of:
the lithium salt;
the nonaqueous solvent;
the diluent; and
the additive.

15. The electrolyte of claim 1, consisting essentially of:
LiFSI, TMPa, and TTFEPi; or
LiFSI, TMPa, TTFEPi, and EC; or
LiFSI, TMPa, TTFEPi, and FEC.

16. (canceled)

17. The electrolyte of claim 1, wherein:
the nonaqueous solvent comprises an organic phosphate, an organic phosphonate, an organic phosphazene, an organic phosphoramide, or a combination thereof; and
wherein the electrolyte has a lithium salt-nonaqueous solvent-diluent molar ratio of 1:x:y where x=0.1-5.0 and y=0.1-8.0.

18. (canceled)

19. The electrolyte of claim 17, further comprising an additive having a different composition than the lithium salt, a different composition than the nonaqueous solvent, and a different composition than the diluent, wherein the electrolyte has a lithium salt-nonaqueous solvent-diluent-additive molar ratio of 1:x:y:z where x=0.1-5.0, y=0.1-8.0, and z=0-1.0.

20. (canceled)

21. The electrolyte of claim 19, consisting essentially of:
LiFSI;
TMPa, TEPa, TTPa, DMMP, or any combination thereof;
TTFEPi, TPPi, 5F-TPrP, HFiP, THFPP, dibutyl phosphite, di-tert-butyl phosphite, or any combination thereof; and
the additive.

22. The electrolyte of claim 19, comprising (i) LiFSI, (ii) TMPa, (iii) TTFEPi, and (iv) EC, FEC, or a combination thereof, in a lithium salt-nonaqueous solvent-diluent-additive molar ratio of 1:x:y:z wherein x=1.1-1.5, y=0.9-1.1, and z=0-0.3.

23. A battery, comprising:
an electrolyte according to claim 1;
an anode, wherein the anode is lithium metal, a carbon-based anode, a silicon-based anode, or a silicon-and carbon-based anode; and
a cathode.

24. The battery of claim 23, wherein the cathode comprises Li_{1+w}NiₓMn_{y}Co_{z}O₂ (x+y+z+w=1, 0≤w≤0.25), LiNiₓMn_{y}Co_{z}O₂ (x+y+z=1), LiCoO₂, LiNi_{0.8}Co_{0.15}Al_{0.05}O₂, LiNi_{0.5}Mn_{1.5}O₄ spinel, LiMn₂O₄, LiFePO₄, Li₄₋ₓMₓTi₅O₁₂ (M=Mg, Al, Ba, Sr, or Ta; 0≤x≤1), MnO₂, V₂O₅, V₆O₁₃, LiV₃O₈, LiM^{C1}ₓM^{C2}₁₋ₓPO₄ (M^{C1} or M^{C2}=Fe, Mn, Ni, Co, Cr, or Ti; 0≤x≤1), Li₃V₂₋ₓM¹ₓ(PO₄)₃ (M¹=Cr, Co, Fe, Mg, Y, Ti, Nb, or Ce; 0≤x≤1), LiVPO₄F, LiM^{C1}ₓM^{C2}₁₋ₓO₂ ((M^{C1} and M^{C2} independently are Fe, Mn, Ni, Co, Cr, Ti, Mg, or Al; 0≤x≤1), LiM^{C1}ₓM^{C2}_{y}M^{C3}_{1-x-y}O₂ ((M^{C1}, M^{C2}, and M^{C3} independently are Fe, Mn, Ni, Co, Cr, Ti, Mg, or Al; 0≤x≤1; 0≤y≤1), LiMn_{2-y}X_{y}O₄ (X=Cr, Al, or Fe, 0≤y≤1), LiNi_{0.5-y}X_{y}Mn_{1.5}O₄ (X=Fe, Cr, Zn, Al, Mg, Ga, V, or Cu; 0≤y<0.5), xLi₂MnO₃·(1−x) LiM^{C1}_{y}M^{C2}_{z}M^{C3}_{1-y-z}O₂ (M^{C1}, M^{C2}, and M^{C3} independently are Mn, Ni, Co, Cr, Fe, or mixture thereof; x=0.3-0.5; y≤0.5; z≤0.5), Li₂M²SiO₄ (M²=Mn, Fe, or Co), Li₂M²SO₄ (M²=Mn, Fe, or Co), LiM²SO₄F (M²=Fe, Mn, or Co), Li₂₋ₓ(Fe_{1-y}Mn_{y})P₂O₇ (0≤y≤1), metal oxides, metal fluorides, a carbon/sulfur composite, or an air electrode.

25. The battery of claim 23, wherein:
(i) the electrolyte consists essentially of LiFSI, TMPa, and TTFEPi, and the anode is lithium metal; or
(ii) the electrolyte consists essentially of LiFSI, TMPa, TTFEPi, and EC, FEC, or a combination thereof, and the anode is a carbon-based anode, a silicon-based anode, or a silicon- and carbon-based anode.

26. (canceled)
